(19) United States
(12) Patent Application Publication
(10) Pub. No.: US 2020/0022074 A1
(43) Pub. Date: Jan. 16, 2020

(54) GATEWAY SELECTION METHOD AND COMMUNICATION SYSTEM

(71) Applicant: NTT DOCOMO, INC., Tokyo (JP)

(72) Inventors: Takuya Shimojou, Tokyo (JP); Daisuke Nojima, Tokyo (JP); Masayoshi Shimizu, Tokyo (JP); Akira Yamada, Tokyo (JP); Shigeru Iwashina, Tokyo (JP)

(73) Assignee: NTT DOCOMO, INC., Tokyo (JP)

(21) Appl. No.: 16/335,566

(22) PCT Filed: Sep. 20, 2017
(86) PCT No.: PCT/JP2017/033868

§ 371 Date: Mar. 21, 2019

(30) Foreign Application Priority Data
Sep. 30, 2016 (JP) 2016-194195

(51) Int. Cl. H04W 48/00; H04W 48/18; H04L 29/06; H04W 8/04

(52) U.S. Cl. CPC H04W 48/17; H04W 48/18; H04L 12/66; H04W 8/04; H04L 63/0892

(57) ABSTRACT

In a communication system (1), a communication service to be used by a piece of UE (30) that has requested access is identified, and an ePDG (40) or a PGW (60) is dynamically selected on the basis of the identified communication service. Thus, it is possible to appropriately provide a communication service requested by a user. Therefore, it is possible to dynamically select the ePDG (40) or the PGW (60) according to requirements of the service requested by the UE (30) (for example, requirements of a network for executing a service). Accordingly, it is possible to provide a suitable communication service to a user of the UE (30) who uses a plurality of services.

### TECHNICAL FIELD

The present invention relates to a gateway selection method and a communication system.

### BACKGROUND ART

In the related art, Non-Patent literature 1 describes that an authentication authorization accounting (AAA) server selects a packet data network gateway (PGW) on the basis of user equipment (UE) that has requested access.

### CITATION LIST

### Non-Patent Literature

[Non-Patent literature 1] 3GPP TS 23.402

### SUMMARY OF INVENTION

### Technical Problem

However, according to the related art, there is only means for selecting a predetermined PGW. Therefore, there is a problem that one piece of UE is likely to be unable to access a plurality of gateway devices (for example, PGWs) suitable for the requirements for respective communication services.

Therefore, an object of the present invention is to allow dynamic selection of a gateway device according to the requirements of a plurality of communication services requested by one piece of UE in order to solve the above problem.

### Solution to Problem

In order to solve the above problem, a gateway selection method according to an embodiment of the present invention is a gateway selection method of selecting a gateway device that performs communication for a communication service that is used by a terminal, which is executed by a communication system including a terminal capable of using a plurality of communication services through non-cellular communication and a plurality of gateway devices, the gateway selection method comprising: an identifying step of identifying a communication service to be used by the terminal; and a selection step of selecting a gateway device corresponding to the communication service identified in the identifying step by referring to correspondence information in which a communication service is associated with a gateway device that performs communication for using the communication service.

Further, a communication system according to an embodiment of the present invention is a communication system including a terminal capable of using a plurality of communication services through non-cellular communication, and a plurality of gateway devices, the communication system comprising: an identifying unit that identifies a communication service to be used by the terminal; and a selection unit that selects a gateway device corresponding to the communication service identified by the identifying unit by referring to correspondence information in which a communication service is associated with a gateway device that performs communication for using the communication service.

According to the present invention, a communication service to be used by a terminal is identified, and a gateway corresponding to the communication service is dynamically selected on the basis of the identified communication service. Thus, it is possible to appropriately provide a communication service to be used by a user. Therefore, it is possible to dynamically select the gateway according to requirements of a plurality of communication services requested by one user terminal (UE) (for example, requirements of a network for executing a communication service). Accordingly, it is possible to provide a suitable communication service to a user of the terminal who uses a plurality of services.

### Advantageous Effects of Invention

According to the present invention, it is possible to dynamically select a gateway device according to requirements of a plurality of communication services requested by one piece of UE.

### BRIEF DESCRIPTION OF DRAWINGS

FIG. 1 is a diagram illustrating a system configuration of a communication system according to an embodiment of the present invention.

FIG. 2 is a diagram illustrating information stored in a HSS.

FIG. 3 is a functional block diagram of a slice selection device.

FIG. 4 is a diagram illustrating information stored in the slice selection device.

FIG. 5 is a diagram illustrating a hardware configuration of the slice selection device.

FIG. 6 is a sequence diagram illustrating an access process at the time of untrusted non-3GPP access.

FIG. 7 is a sequence diagram illustrating an access process at the time of trusted non-3GPP access.

FIG. 8 is a diagram illustrating an example of correspondence information of another embodiment.

### DESCRIPTION OF EMBODIMENTS

Hereinafter, modes for carrying out the present invention will be described in detail with reference to the accompanying drawings. It should be noted that in the description of the drawings, the same elements are denoted by the same reference numerals and redundant description will be omitted.

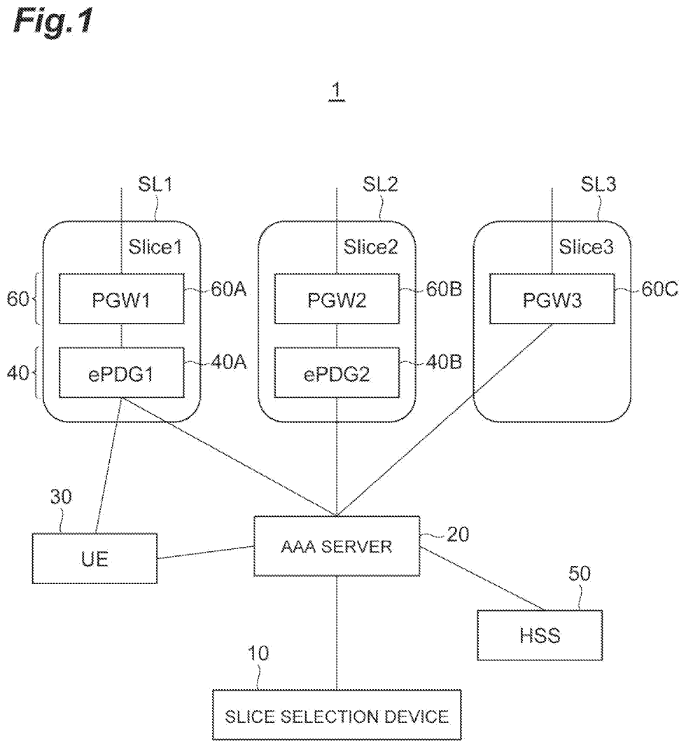

FIG. 1 is a system configuration diagram of a communication system 1 according to an embodiment of the present invention. The communication system 1 includes a slice selection device 10, an AAA server 20, a piece of UE 30 with which a plurality of communication services can be used, a plurality of ePDGs 40, an HSS 50, and a plurality of PGWs 60. Further, this communication system 1 is a system that provides communication services through non-cellular communication (non-3GPP access).

Here, the non-cellular communication means communication (a wireless local area network (LAN) or the like) other than cellular communication. Further, the communication service is a service using communication, and is a service such as moving image distribution or inter-vehicle communication. In each communication service, required network requirements are different. The UE 30 stores a service type which is information indicating the network requirements, as information indicating the communication service.

The slice selection device 10 is a device (a slice selection function) that selects a slice corresponding to a communication service that is used by the UE 30 in response to an access request from the UE 30. The slice is a virtual network or a service network logically generated on a network infrastructure by virtually separating resources of links and nodes of a network device and coupling the separated resources, and the slices include separated resources and do not interfere with each other. A slice SL1 secures resources of the ePDG 40A and the PGW 60A, and a slice SL2 secures resources of the ePDG 40B and the PGW 60B.

The slice selection device 10 stores information in which the service type and addresses of the gateway devices (the ePDG 40 and the PGW 60) constituting the slice are associated with each other. When the slice selection device 10 receives an address transmission request from the AAA server 20, the slice selection device 10 transmits the addresses of the ePDG 40 and the PGW 60 according to the request to the AAA server 20 by referring to the above information.

The AAA server 20 is a server device that performs access control of the UE 30 that performs access via a wireless LAN.

The user equipment (UE) 30 (terminal) including a smartphone or a tablet terminal can communicate with this communication system 1 through wireless communication or the like. Further, the UE 30 stores identification information (user information) of the UE 30 and transmits the information to the ePDG 40 or the AAA server 20. When untrusted non-3GPP access is used, the UE 30 communicates with the AAA server 20 via the ePDG 40. Further, when trusted non-3GPP access is used, the UE 30 communicates with the AAA server 20 without passing through the ePDG 40. The AAA server 20 transmits an access type indicating which of the trusted non-3GPP access and the untrusted non-3GPP access is used, to the slice selection device 10.

The ePDG 40 is a unit that transmits user data as a gateway device between a core network and the wireless LAN, and is a gateway device that communicates with the UE 30.

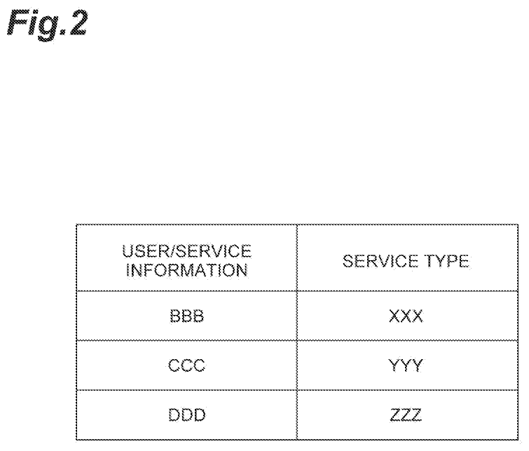

The HSS 50 is a server that manages subscriber information including contract information, authentication information, communication service information, terminal type information, and location information of a communication terminal such as the UE 30 in a database. The HSS 50 includes user information (for example, network access identity (NAI)) and a service type. For example, this information may include user information and a service type, as illustrated in FIG. 2.

The PGW 60 is a gateway between a packet data network (PDN) and the core network, and transmits user data (packet data). That is, the PGW 60 is a gateway device that transfers packets.

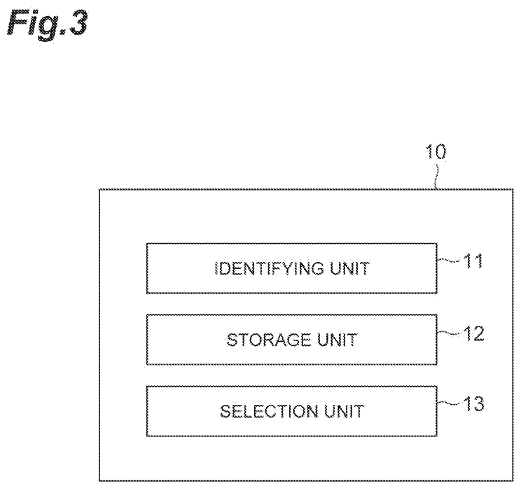

Next, components of the slice selection device 10 having characteristics in the communication system 1 will be described with reference to FIG. 3.

As illustrated in FIG. 3, the slice selection device 10 includes an identifying unit 11, a storage unit 12, and a selection unit 13.

The identifying unit 11 is a unit that identifies a communication service to be used by the UE 30. The identifying unit 11 acquires the service type and the access type from the AAA server 20 and receives the address selection request. When the identifying unit 11 receives the address selection request, the identifying unit 11 sends the service type and the access type to the selection unit 13.

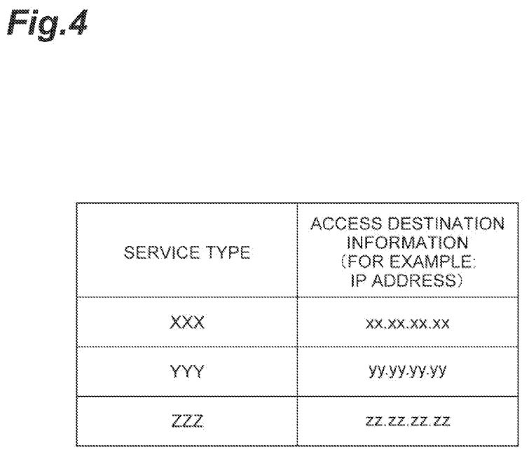

The storage unit 12 is a unit that stores information (correspondence information) in which the service type is associated with the address of the ePDG 40 or the PGW 60 corresponding to the service type. An example of information stored in the storage unit 12 is illustrated in FIG. 4. As illustrated in FIG. 4, a “service type” indicating the service type and “access destination information” that is address information indicating an address of the access destination (address of the ePDG 40 or the PGW 60) are stored in association with each other. Thus, the storage unit 12 stores address information of the ePDG 40 corresponding to the service type and the address information of the PGW 60 corresponding to the service type.

The selection unit 13 is a unit that selects the PGW 60 or the ePDG 40 corresponding to the service type by referring to the information stored in the storage unit 12. The selection unit 13 acquires the service type and the access type from the identifying unit 11. Subsequently, when the access type indicates “non-trusted non-3GPP access”, the selection unit 13 searches for the address information of the ePDG 40 corresponding to the acquired service type and the address information of the PGW 60 corresponding to the service type by referring to the information stored in the storage unit 12. Thus, the selection unit 13 selects the ePDG 40 and the PGW 60 that are access destinations by searching for the address information of the ePDG 40 and the address information of the PGW 60 that have been searched for. Subsequently, the selection unit 13 transmits the address information of the ePDG 40 and the address information of the PGW 60 that have been searched for to the AAA server 20.

Further, when the access type indicates “trusted non-3GPP access”, the selection unit 13 searches for the address information of the PGW 60 corresponding to the acquired service type by referring to the information stored in the storage unit 12. Thus, the selection unit 13 selects the PGW 60 that is an access destination by searching for the address information of the searched PGW 60 that has been searched for. The selection unit 13 transmits the address information of the PGW 60 that has been searched for to the AAA server 20.

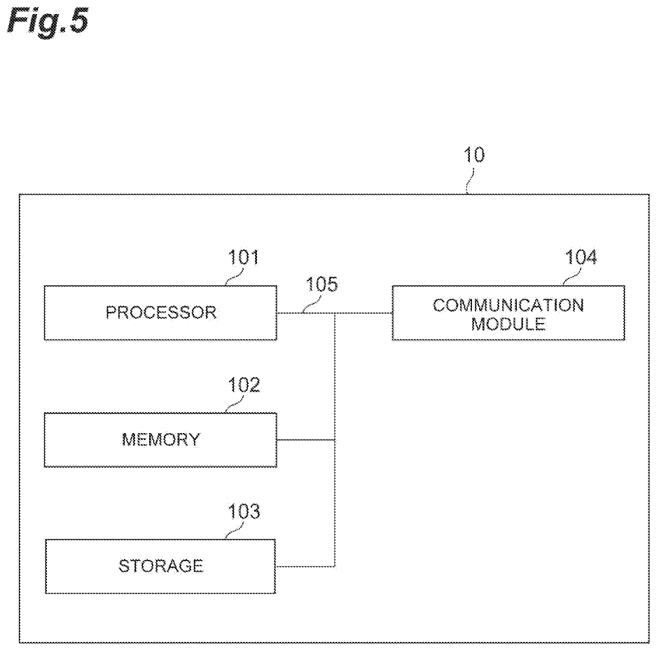

Subsequently, FIG. 5 illustrates a hardware configuration of the slice selection device 10 according to the embodiment. Functional blocks (constituent units) of the slice selection device 10 are realized by an arbitrary combination of hardware and/or software. Further, means for realizing each functional block is not particularly limited. That is, each functional block may be realized by one physically and/or logically coupled device or may be realized by a plurality of devices in which two or more physically and/or logically separated devices may be accessed directly and/or indirectly (for example, by a cable and/or wirelessly).

For example, the slice selection device 10 or the like according to an embodiment of the present invention may function as a computer that selects a slice. The slice selection device 10 described above may be physically configured as a computer device including a processor 101, a memory 102, a storage 103, a communication module 104, and the like.

It should be noted that in the following description, a term “device” can be referred to as a circuit, device, unit, or the like. The hardware configuration of the slice selection device 10 may be configured to include one or a plurality of devices illustrated in FIG. 5 or may be configured not to include some of the devices.

Each function in the slice selection device 10 is realized by loading predetermined software (program) into hardware such as the processor 101 or the memory 102 so that the processor 101 performs computation to control communication using the communication module 104 and reading and/or writing data from and/or to the memory 102 and the storage 103.

The processor 101 operates, for example, an operating system to control the entire computer. The processor 101 may include a central processing unit (CPU) including an interface with a peripheral device, a control device, a computation device, a register, and the like. For example, the identifying unit 11 and the selection unit 13 described above may be realized by the processor 101.

Further, the processor 101 reads a program (program code), a software module, and data from the storage 103 and/or the communication module 104 to the memory 102, and executes various processes according to these. As the program, a program for causing the computer to execute at least part of the operations described in the above-described embodiment is used. For example, the slice selection device 10 may be realized by a control program stored in the memory 102 and operating on the processor 101 or other functional blocks may be realized in a similar manner. Although the example in which the various processes described above are executed by one processor 101 has been described, the processes may be executed simultaneously or sequentially by two or more processors 101. The processor 101 may be realized using one or more chips. It should be noted that the program may be transmitted from a network via an electrical communication line.

The memory 102 is a computer-readable recording medium and is configured of, for example, at least one of a read only memory (ROM), an erasable programmable ROM (EPROM), an electrically erasable programmable ROM (EEPROM), and a random access memory (RAM). The memory 102 may be referred to as a register, a cache, a main memory (a main storage device), or the like. The memory 102 can store an executable program (program code), a software module, and the like for implementing the method according to an embodiment of the present invention.

The storage 103 is a computer-readable recording medium, and may be configured of, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 103 may be referred to as an auxiliary storage device. The storage medium described above may be, for example, a database including the memory 102 and/or the storage 103, a server, or other appropriate medium.

The communication module 104 is hardware (a transmission and reception device) for performing communication between computers via a wired and/or wireless network, and is also referred to as, for example, a network device, a network controller, or a network card.

In addition, the respective devices such as the processor 101 and the memory 102 are connected by a bus 105 for communicating information. The bus 105 may be configured of a single bus or may be configured of different buses between the devices.

Further, the slice selection device 10 may include hardware such as a microprocessor, a digital signal processor (DSP), an application specific integrated circuit (ASIC), a programmable logic device (PLD), or a field programmable gate array (FPGA), and part or all of each functional block may be realized by hardware. For example, the processor 101 may be implemented with at least one piece of such hardware. The above is a configuration of the slice selection device 10 according to the present embodiment.

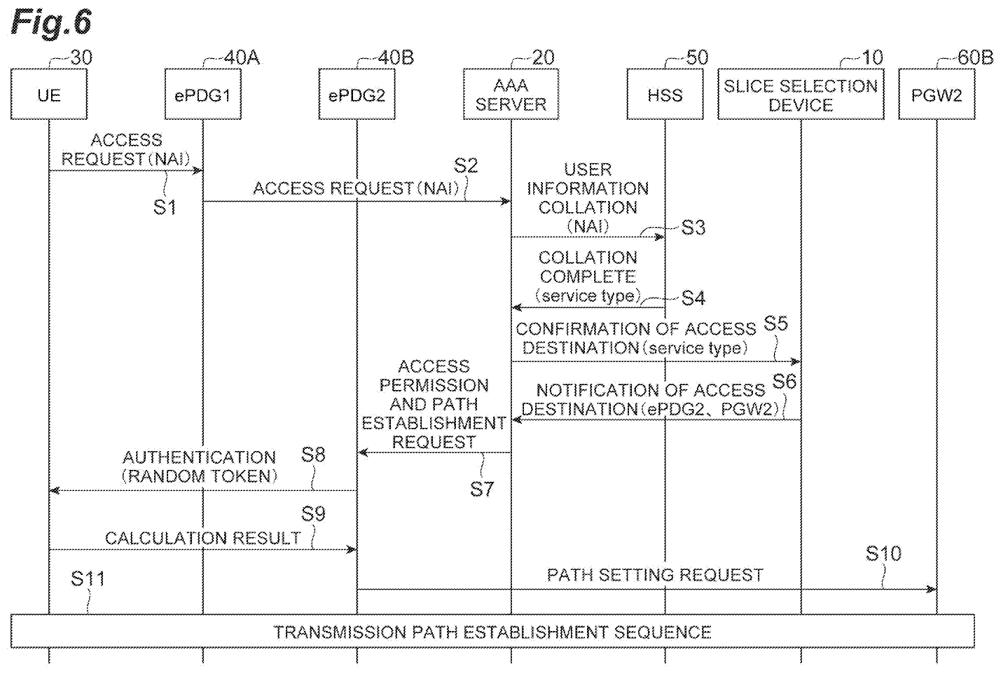

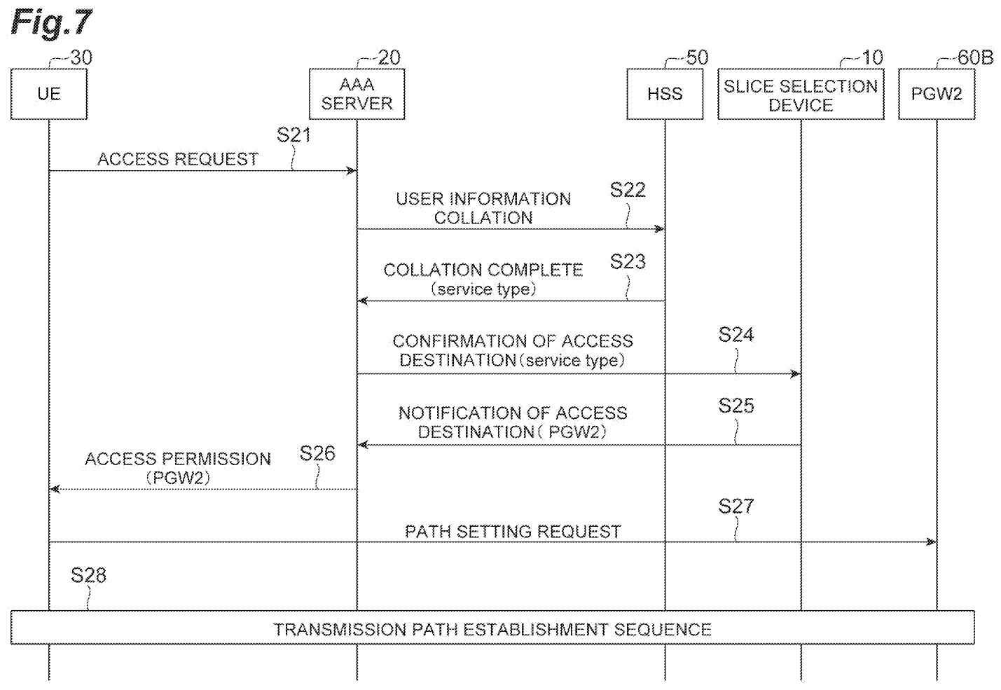

Next, a method of selecting the ePDG 40 or the PGW 60 in the communication system 1 will be described with reference to FIGS. 6 and 7. FIG. 6 is a sequence diagram illustrating an access process at the time of non-trusted non-3GPP access, and FIG. 7 is a sequence diagram illustrating an access process at the time of trusted non-3GPP access.

First, an access process at the time of untrusted non-3GPP access will be described with reference to FIG. 6.

First, the UE 30 transmits an NAI to the ePDG 40A and sends an access request (step S1). When the ePDG 40A receives the access request from the UE 30, the ePDG 40A sends an access request to the AAA server 20 (step S2). The AAA server 20 transmits the NAI received from the ePDG 40A and sends a user information collation request to the HSS 50 (step S3). The HSS 50 searches for the service type corresponding to the received NAI by referring to the stored information, and transmits the service type that has been searched for to the AAA server 20 (step S4). The AAA server 20 transmits the service type and the access type to the slice selection device 10 and sends a request for transmission of the access destination, and the identifying unit 11 of the slice selection device 10 receives the service type and the access type (step S5). The selection unit 13 of the slice selection device 10 selects the addresses of the ePDG 40B and the PGW 60B as the addresses of the ePDG 40 and the PGW 60 corresponding to the service type, and transmits the addresses of the ePDG 40B and the PGW 60B to the AAA server 20 (step S6). The AAA server 20 transmits the address of the PGW 60B to the ePDG 40B on the basis of the address of the ePDG 40B received from the slice selection device 10 and sends an access permission and path establishment request (step S7).

The ePDG 40 transmits a random token to the UE 30 and sends an authentication request (step S8). The UE 30 performs a calculation process based on the random token and transmits a result of the calculation to the ePDG 40B (step S9). The ePDG 40B performs authentication using the calculation result received from the UE 30, sends a path setting request to the address of the PGW 60B received from the slice selection device 10 (step S10), and establishes a transmission path (step S11).

Next, an access process at the time of trusted non-3GPP access will be described with reference to FIG. 7. First, the UE 30 transmits an NAI to the AAA server 20 and sends an access request (step S21). The AAA server 20 transmits the NAI and sends a user information collation request to the HSS 50 (step S22). The HSS 50 searches for the service type corresponding to the received NAI by referring to the stored information, and transmits the service type that has been searched for to the AAA server 20 (step S23). The AAA server 20 transmits the service type and the access type to the slice selection device 10 and sends a request for transmission of the access destination, and the identifying unit 11 of the slice selection device 10 receives the service type and the access type (step S24). The selection unit 13 of the slice selection device 10 selects the addresses of the PGW 60B as the address of the PGW 60 corresponding to the service type, and transmits the address of the PGW 60B to the AAA server 20 (step S25). The AAA server 20 transmits the address of the PGW 60B to the UE 30 and permits access (step S26).

The UE 30 sends a path setting request to the PGW 60B on the basis of the received address of the PGW 60B (step S27) and establishes a transmission path (step S28).

In the above-described embodiment, the case in which the service type is associated with the address of the ePDG 40 or the PGW 60 has been described. Information capable of identifying a service, such as a piece of UE usage type, a service parameter, an access point name (APN), or a dedicated core network (DCN) may be used instead of this service type. Further, information in which the service type is associated with the APN or information in which the service type is associated with the DCN ID may be associated with the address of the ePDG 40 or the PGW 60.

Although the slice selection device 10 is an independent device in the above embodiment, the slice selection device 10 may be incorporated in another device. For example, the AAA server 20 or the HSS 50 may function as the slice selection device 10.

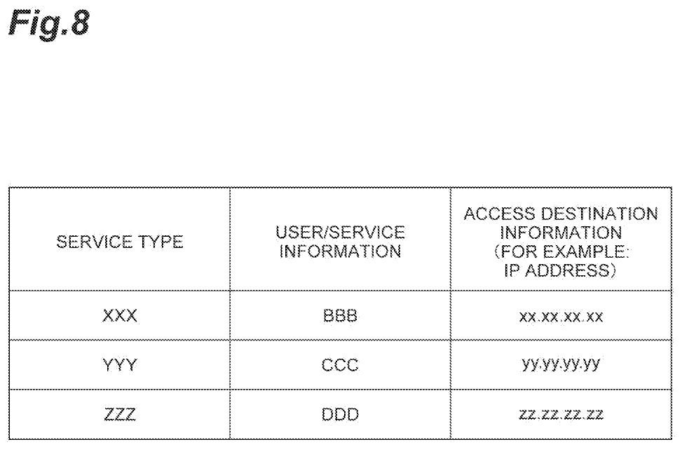

In the above embodiment, the case in which the HSS 50 stores the information in which the user information and the service type are associated with each other, and the slice selection device 10 stores the information in which the service type and the access destination information are associated with each other has been described above. Instead, the slice selection device 10 may store information obtained by combining two pieces of such information. That is, the slice selection device 10 may store information in which user information, service type, and access destination information are associated with each other as illustrated in FIG. 8. In this case, the AAA server 20 transmits the user information to the slice selection device 10 and makes an inquiry about access destination information without inquiring of the HSS 50 about the service type.

As described above, in the communication system 1, the communication service to be used by the UE 30 that has requested access is identified, and the ePDG 40 or the PGW 60 is dynamically selected on the basis of the identified communication service. Thus, it is possible to appropriately provide the communication service requested by the user. Therefore, it is possible to dynamically select the ePDG 40 or the PGW 60 according to the requirements of the service requested by the UE 30 (for example, requirements for a network for executing the service). Thus, it is possible to provide a suitable communication service to the user of the UE 30 that uses the plurality of services.

Further, the slice selection device 10 of the communication system 1 selects the ePDG 40 or the PGW 60 on the basis of the communication service. In this case, even when a request for non-trusted non-3GPP access is made by the UE 30, the ePDG 40 corresponding to the communication service can be selected.

Further, the slice selection device 10 stores information in which information for identifying the UE 30 is associated with the service type, and identifies a communication service to be used by the UE 30 by referring to the information. In this case, since it is not necessary for another device to identify the communication service to be used by the UE 30, it is possible to identify the communication service with a simple configuration.

The software is referred to as software, firmware, middleware, microcode, or hardware description language, and can be construed widely to mean instructions, an instruction set, codes, code segments, program codes, a program, a subprogram, a software module, an application, a software application, a software package, a routine, a subroutine, an object, an executable file, an execution thread, a procedure, a function, or the like even though the software is referred to by another name.

In addition, software, instructions, and the like may be transmitted and received via a transmission medium. For example, when the software is transmitted from a website, a server, or another remote source using wired technology such as a coaxial cable, a fiber optic cable, a twisted pair, or a digital subscriber line (DSL) and/or wireless technology such as infrared rays, wireless technology, or microwaves, these wired and/or wireless technologies are included within a definition of the transmission medium.

The information, signals, or the like described in the patent specification may be represented using any of a variety of different technologies. For example, data, instruction, command, information, signal, bit, symbol, chip, or the like that may be mentioned throughout the above description may be represented by voltage, current, electromagnetic waves, magnetic field or particles, or optical field or photons, or a combination thereof.

It should be noted that the terms shown in the patent specification and/or terms necessary for understanding of the patent specification may be replaced with terms having the same or similar meanings.

The terms “system” and “network” used in the patent specification are used interchangeably.

Further, the information, parameters, and the like shown in the patent specification may be represented as absolute values, may be represented as relative values with respect to predetermined values, or may be represented by other corresponding information. For example, wireless resource may be indicated by an index.

A description “on the basis of” used in the patent specification does not mean “on the basis of only” unless explicitly stated otherwise. In other words, the description “on the basis of” means both “on the basis of only” and “on the basis of at least”.

Further, the “means” in the configuration of each of the above devices may be replaced with “unit”, “circuit”, “device”, or the like.

“Including”, “comprising”, and modifications thereof when used in the patent specification or claims are intended to encompass the term “equipped with”. Further, the term “or” used in the patent specification or claims is intended not to be an exclusive disjunction.

In the patent specification, it is assumed that a plurality of devices are included in cases other than a case in which there is only one device obviously from the context or technically.

Further, each aspect/embodiment described in the patent specification can be applied to a system that uses long term evolution (LTE), LTE-Advanced (LTE-A), SUPER 3G; IMT-Advanced, 4G, 5G, Future Radio Access (FRA), W-CDMA (registered trademark), GSM (registered trademark), CDMA 2000, Ultra Mobile Broadband (UMB), IEEE 802.11 (Wi-Fi), IEEE 802.16 (WiMAX), IEEE 802.20, Ultra-Wide Band (UWB), Bluetooth (registered trademark), or another suitable system, and/or a next-generation system expanded based on these.

Further, an order of a processing procedure, sequence, flowchart, and the like of each aspect/embodiment described in the patent specification may be changed as long as there is no inconsistency. For example, in the method described in the patent specification, elements of the various steps are presented in an exemplary order and are not limited to the presented specific order.

Input or output information or the like may be stored in a specific place (for example, a memory) or managed in a management table. Information or the like to be input or output can be overwritten, updated, or additionally written. Output information or the like may be deleted. Input information or the like may be deleted. Input information or the like may be transmitted to another device.

Each aspect or embodiment described in the patent specification may be used singly or may be in combination, or may be switched according to execution and used. Further, a notification of predetermined information (for example, a notification of “being X”) is not limited to being performed explicitly, and may be performed implicitly (for example, not by notifying the predetermined information).

Throughout this disclosure, it is assumed that both singular and plural are intended to be included unless singular is clearly indicated.

Although the present invention has been described above in detail, it will be obvious to those skilled in the art that the present invention is not limited to the embodiments described in the patent specification. The present invention can be implemented in various and modified aspects without departing from the spirit and scope of the present invention as defined by the claims. Therefore, the description of the patent specification is intended for illustration and does not have any restrictive meaning with respect to the present invention.

### REFERENCE SIGNS LIST

1 . . . Communication system, 10 . . . Slice selection device, 11 . . . Identifying unit, 12 . . . Storage unit, 13 . . . Selection unit, 20 . . . AAA server, 30 . . . UE (terminal), 40 . . . ePDQG 50 . . . HSS, 60 . . . PGW, 101 . . . Processor, 102 . . . Memory, 103 . . . Storage, 104 . . . Communication module, 105 . . . Bus.

1. A gateway selection method of selecting a gateway device that constitutes a slice satisfying requirements of a communication service that is used by a terminal, the gateway selection method being executed by a communication system including the terminal capable of using a plurality of communication services through non-cellular communication and a plurality of gateway devices, the communication system being a system where a plurality of slices are generated, each slice being a virtual network or a service network logically generated on a network infrastructure, the gateway selection method comprising:
an identifying step of identifying a communication service to be used by the terminal; and
a selection step of selecting a gateway device corresponding to the communication service identified in the identifying step by referring to correspondence information in which a communication service is associated with a gateway device that constitutes a slice satisfying requirements of the communication service.

2. The gateway selection method according to claim 1, wherein the selection step includes: selecting a gateway device that communicates with the terminal and a gateway device that performs packet transfer, both of the gateway devices corresponding to the communication service identified in the identifying step.

3. The gateway selection method according to claim 1,
wherein information for identifying the terminal is further associated in the correspondence information, and
the identifying step includes: identifying a communication service to be used by the terminal by referring to the correspondence information.

4. A communication system including a terminal capable of using a plurality of communication services through non-cellular communication, and a plurality of gateway devices, the communication system being a system where a plurality of slices are generated, each slice being a virtual network or a service network logically generated on a network infrastructure, the communication system comprising:
a circuitry configured to:
identify a communication service to be used by the terminal; and
select a gateway device corresponding to the identified communication service by referring to correspondence information in which a communication service is associated with a gateway device that constitutes a slice satisfying requirements of the communication service.

5. The gateway selection method according to claim 2,
wherein information for identifying the terminal is further associated in the correspondence information, and
the identifying step includes: identifying a communication service to be used by the terminal by referring to the correspondence information.
